(19) United States
(12) Patent Application Publication
(10) Pub. No.: US 2026/0146688 A1
(43) Pub. Date: May 28, 2026

(54) CONDUIT SYSTEMS AND METHODS

(71) Applicant: The Boeing Company, Arlington, VA (US)

(72) Inventor: Bryce Avery Van Dyke, Snohomish, WA (US)

(73) Assignee: The Boeing Company, Arlington, VA (US)

(21) Appl. No.: 18/960,237

(22) Filed: Nov. 26, 2024

(51) Int. Cl. F16L 3/22; B64D 33/04; B64D 33/10

(52) U.S. Cl. CPC F16L 3/22; B64D 33/04; B64D 33/10

(57) ABSTRACT

A conduit system and method includes a mounting bar that extends between a first end and a second end. The mounting bar includes a mating surface that extends between the first end and the second end. The mating surface includes one or more mating features. The conduit system includes one or more conduits each including an outer surface that is operably coupled with at least one of the mating features of the mounting bar. The conduits are operably coupled with the mating surface of the mounting bar via a thermal bond or an adhesive bond.

### FIELD OF THE DISCLOSURE

Examples of the present disclosure generally relate to conduit or ducting system and methods for manufacturing a conduit or ducting system.

### BACKGROUND OF THE DISCLOSURE

An aircraft may include several ducts, conduits, pipes, or the like, that may extend between different regions of the aircraft. The conduits may be used to carry bundles of wires, fluids (gases and/or liquids) such as cooling fluids, exhaust, or the like. In certain aircrafts, such as commercial airplanes, the conduits may be positioned and extend within compartments that are above and below an interior cabin of the aircraft. the conduits may be installed in elevated positions within the compartments by being coupled with aircraft structures proximate to the interior cabin.

In order to maintain positions of the different ducts, one or more mounting or spanner bars may be used. The mounting bars may be positioned to extend across one or more ducts and may be capable of supporting different types and sizes of ducts. Multiple components, however, are required to couple the different ducts to the mounting bars and to couple the multiple mounting bars to the aircraft. Furthermore, the support structures used to connect ducts within the aircrafts are manufactured primarily of rigid materials, thus tolerance mismatch between a rigid duct system and a rigid aircraft structure require complex combinations of mechanical connections with self-aligning bearings and tightly tolerance interfaces.

As can be appreciated, however, the additional coupling components can add weight to the overall weight of the aircraft. Moreover, assembly and/or installation times may be impacted in order to couple groups of rigid ducts together with a rigid mounting bar, and then to install the assembly within the aircraft.

### SUMMARY OF THE DISCLOSURE

A need exists for a conduit system that includes components (e.g., conduits, mounting bars, spanner bars, etc.) that may be manufactured of one or more flexible materials that may be non-adhesively (e.g., thermally, etc.) and/or adhesively bonded together, in order to substantially reduce part count, reduce weight, reduce installation and/or assembly time, or the like. With those needs in mind, certain examples of the present disclosure provide a conduit system and method that includes a mounting bar that extends between a first end and a second end. The mounting bar includes a mating surface that extends between the first end and the second end. The mating surface includes one or more mating features. The conduit system includes one or more conduits each including an outer surface that is operably coupled with at least one of the mating features of the mounting bar. The conduits may be operably coupled with the mating surface of the mounting bar via a thermal bond or an adhesive bond.

In one example, the mounting bar and the conduits may be manufactured of a flexible material. Optionally, the mounting bar may be manufactured of a first material that has one or more first characteristics and the conduits may be manufactured of a second material that has one or more characteristics. At least one of the first characteristics of the first material may be the same as at least one of the second characteristics of the second material. In at least one example, the mounting bar and the conduits may be manufactured of a thermoplastic fluoropolymer.

In one example, the mating features of the mounting bar may have a shape and/or size that corresponds to a shape and/or size of at least one of the conduits. In one example, the mounting bar can maintain a position of the conduits. Optionally, the conduit system may include a first conduit and a second conduit. The mounting bar may maintain a position of the first conduit relative to a position of the second conduit.

In one example, the mounting bar and the conduits may be disposed within an interior portion of an aircraft system. In one example, the mounting bar may include one or more passages that may receive one or more fastening elements. The mounting bar may be operably coupled with a portion of a frame structure of an aircraft system via the one or more fastening elements. Optionally, the conduit system may include a fastener system that includes one or more clamping devices and one or more fastening elements. The mounting bar may include one or more passages that may receive the one or more fastening elements. Each of the clamping devices may include a first coupling portion and a second coupling portion. The first coupling portion may be operably coupled with the mounting bar via the one or more fastening elements and the second coupling portion may be operably coupled with a frame structure of an aircraft system.

Certain examples of the present disclosure provide a conduit system that includes one or more conduits, each extending a length in a first direction. Each of the conduits includes an outer surface. The conduit system includes plural mounting bars. Each of the mounting bars may be disposed at different locations along the length of the conduits. The mounting bars can include mating surfaces that include one or more mating features. The conduits may be operably coupled with at least one of the mating features of each of the mounting bars via one of a thermal bond or an adhesive bond.

Certain examples of the present disclosure provide a method that includes forming a thermal bond between a mating feature of a mounting bar with one or more outer surfaces of one or more conduits. The mating feature may be disposed along a mating surface of the mounting bar. The mounting bar extends between a first end and a second end in a first direction. The conduits extend in a second direction that is different than the first direction. The mounting bar and the conduits may be manufactured of a thermoplastic fluoropolymer.

### BRIEF DESCRIPTION OF THE DRAWINGS

FIG. 1 illustrates a perspective view of a conduit system, according to an example of the present disclosure.

FIG. 2 illustrates a front view of a conduit system, according to an example of the present disclosure.

FIG. 3 illustrates a front view of a mounting bar of the conduit system shown in FIG. 2, according to an example of the present disclosure.

FIG. 4 illustrates a cross-sectional view of a portion of the conduit system shown in FIG. 2, according to an example of the present disclosure.

FIG. 5 illustrates a cross-sectional view of a portion of the conduit system shown in FIG. 2, according to an example of the present disclosure.

FIG. 6 illustrates a perspective view of an aircraft, according to an example of the present disclosure.

FIG. 7 illustrates a flowchart of a method, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

As described herein, examples of the present disclosure provide conduit systems that may include one or more mounting bars and one or more conduits that may be operably coupled with the mounting bars. The mounting bars may include one or more mating features that may be shaped and/or sized to correspond with a shape and/or size of one or more conduits. For example, the mating features may be concave cutouts or concave pockets that may extend into a body of the mounting bar and away from a mating surface of the mounting bar. For example, the mating features may be pockets or receiving elements that may be shaped, sized, and/or positioned to receive a portion of one of the conduits therein. The mounting bars and the conduits may be manufactured of one or more materials that may be thermally bonded together. For example, the conduits and the mounting bars may be operably coupled with each other via a thermal bond and/or a thermal bonding process. Optionally, the mounting bars and conduits may be manufactured of one or more materials that may be operably coupled together via a mechanical connection (e.g., fasteners, hook and loop fasteners, etc.) and/or an adhesive bond and/or a non-adhesive bond.

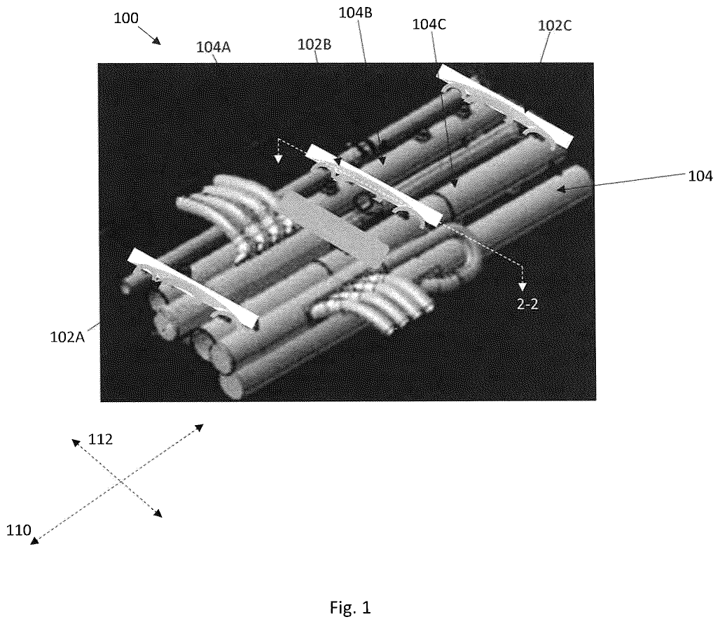

FIG. 1 illustrates a perspective view of a conduit system 100, according to one example of the present disclosure. The conduit system 100 includes one or more conduits 104 that may be arranged to extend in a first direction 110. The conduits 104 may be referred to as ducts, ducting passages, or the like. In one example, the conduits may include interior passages extending along center axes of the conduits 104 with one or more wires, bundles of wires, pipes, fluids (e.g., gases, liquids, etc.), or the like, that may be disposed and/or extend therein.

The conduit system 100 includes plural mounting bars 102 that may be operably coupled with one or more of the conduits 104. The mounting bars 102 may extend in a second direction 112, that is substantially perpendicular to the first direction 110. In the illustrated example, the conduit system 100 includes plural conduits 104 and three mounting bars 102A-C that are positioned at different locations along the length of the conduits 104 in the first direction 110. In alternative examples, the conduit system may include less than three or more than three mounting bars 102A-C. Additionally, each of the mounting bars 102A-C illustrated in FIG. 1 has a substantially uniform shape, size, and arrangement as each other mounting bar. In alternative examples, one or more mounting bars may have any alternative shape, size, arrangement, configuration, or the like, relative to one or more other mounting bars.

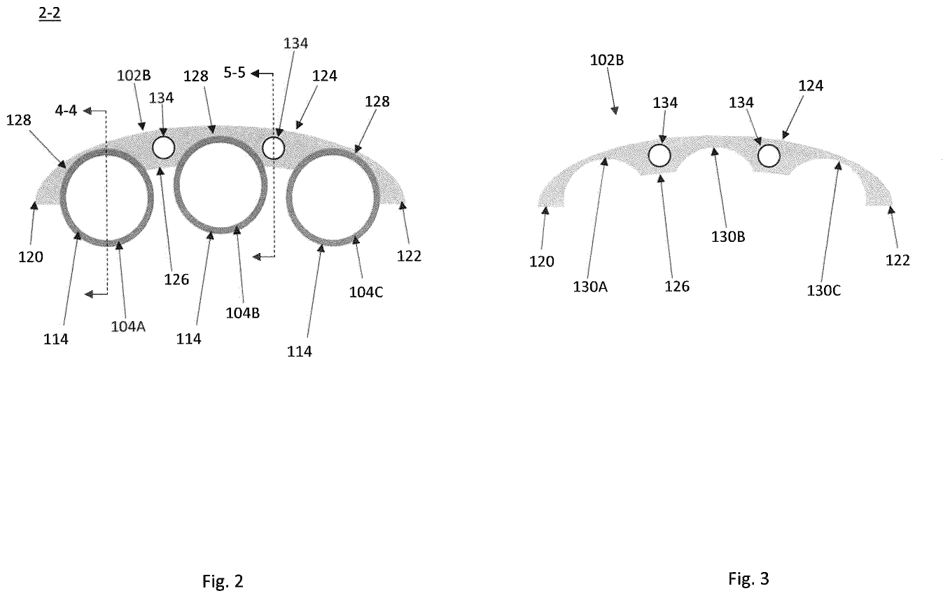

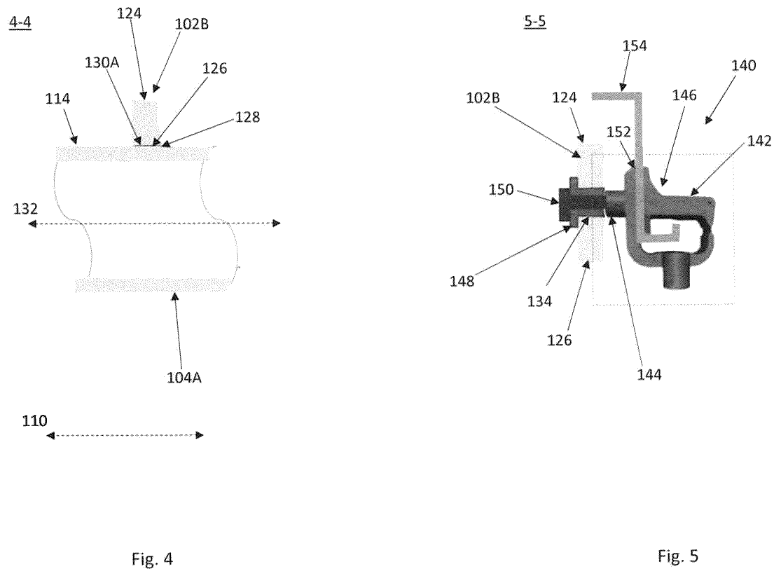

FIG. 2 illustrates a cross-sectional view of a portion of the conduit system 100, according to an example of the present disclosure. The cross-sectional view illustrates one of the mounting bars 102B and plural conduits 104A-C. FIG. 3 illustrates a cross-sectional view of the mounting bar 102B. FIG. 4 illustrates a cross-sectional view of a portion of the conduit system 100. Referring to FIGS. 1-4, in the illustrated example, the mounting bar 102B extends between a first end 120 and a second end 122 in the second direction 112. The mounting bar 102B includes a free surface 124 and a mating surface 126 that is positioned facing towards the conduits 104A-C.

The mating surface 126 of the mounting bar 102B includes plural mating features 130A-C. In the illustrated example, the mating features 130A-C are pockets, concave cutouts, divots, indentations, or the like, that extend into the body of the mounting bar 102B and away from the mating surface 126 of the mounting bar 102B. In one example, the mating features 130A-C may be shaped, sized, and/or positioned at locations between the first and second ends 120, 122 of the mounting bar 102B based at least in part on the one or more conduits 104A-C to which the mounting bar 102B will be coupled. For example, the mating features 130A-C may be concave cutouts and/or curved pockets that extend into the body of the mounting bar 102B and may be shaped and sized based at least in part on a shape and size of a curvature of one of the conduits 104A-C. In the illustrated example, the three mating features 130A-C have substantially similar shapes and sizes relative to each other. In alternative examples, one or more of the mating features 130A-C may have a shape and/or size that differs from a shape and/or size of another mating feature. For example, one mating feature may be smaller than another mating feature based on one of the conduits having a diameter that is smaller than a diameter of another conduit.

In one example, the mounting bars and/or the conduits may be manufactured of a flexible material that may allow the mounting bars and/or the conduits to flex, bend, move, adjust position, or the like, such as during assembly of the conduit system, during installation of the conduit system within a system (e.g., an aircraft system), during maintenance and/or repair of the installed conduit system, or the like.

In one or more examples, the mounting bars 102 may be manufactured of a first material and the conduits 104 may be manufactured of a second material. The first and second materials may be the same or substantially the same materials, may share or have one or more common material properties, or the like. As one example, the mounting bars and the conduits may be manufactured of a thermoplastic fluoropolymer. For example, the mounting bars and the conduits may be manufactured of a flexible polyvinylidene fluoride (PVDF) closed cell foam material. The PVDF closed cell foam material may allow thermal insulation to also act as a pressure retention element, which may eliminate the need for separate and/or additional duct and insulation. As another example, one of the mounting bars or the conduits may be manufactured of polyvinylidene fluoride (PVDF) and the other mounting bars or the conduits may be manufactured of another thermoplastic fluoropolymer. Optionally, the mounting bars and/or the conduits may be manufactured of another flexible material (e.g., another closed cell foam material, another polymer, or the like).

The one or more conduits 104A-C may be operably coupled with the mounting bar 102 at one or more bonding locations 128. For example, an outer surface 114 of each of the conduits 104A-C may be operably coupled with a corresponding mating feature 130A-C of the mounting bar 102B at a corresponding bonding location 128. For example, in the illustrated example shown in FIG. 4, the outer surface 114 of the conduit 104A is operably coupled with the mating feature 130A of the mounting bar 102B at the bonding location 128. The conduit 104A extends along a center axis 132 in the first direction 110.

The conduits 104A-C may be operably coupled with the mounting bar 102B such that the mounting bar 102B may maintain a position of each of the conduits 104A-C. For example, the mounting bar 102B may prohibit movement of the conduits 104A-C in the first direction 110, in the second direction 112, or the like. Additionally, the mounting bar 102B may maintain a position of one of the conduits 104A relative to a position of the other conduits 104B-C.

In one or more examples, one or more properties of the material of the mounting bar 102 and one or more properties the material of the conduits 104 may allow the conduits 104 to be operably coupled with the mounting bar 102 via a thermal bond. For example, during an assembly of the conduit system 100, the one or more conduits 104 may be thermally bonded to the mating surface 126 of the mounting bar 102 such that at least a portion of the material of the conduits 104 is bonded to, fused with, webbed together with, or the like, a portion of the material of the mounting bar 102 responsive to the mounting bar 102 and the conduits 104 being exposed to one or more thermal bonding conditions (e.g., temperatures, pressures, etc.). In another example, the conduits 104 may be operably coupled with the mounting bar 102 via an adhesive bond. For example, an adhesive material may be positioned between an outer surface 114 of one or more of the conduits 104 and the mating surface 126 of the mounting bar 102 to adhere the conduits 104 with the mounting bar 102.

FIG. 5 illustrates a cross-sectional view of another portion of the conduit system 100 shown in FIG. 2. In one or more example, the conduit system 100 may include and/or be operably coupled with a fastener system 140. The fastener system 140 may allow the conduit system 100 to be operably coupled with, disposed within, and/or installed within a system, such as an interior portion of an aircraft system. In one example, the fastener system 140 includes one or more fastening elements 148, 150 that may be operably coupled with the mounting bar 102B. For example, the mounting bar 102B may include one or more passages 134 that may receive one or more of the fastening elements 148, 150. In the illustrated example, the fastening element 148 may represent a spacer (e.g., an injection molded spacer device, or the like) and the fastening element 150 may represent a screw, a rivet, a bolt, or the like. In one example, the fastening element 148 can be manufactured of an elastomeric or rubber material that may accommodate a tolerance mismatch, structural deflection, or the like.

The fastener system 140 also includes a clamping device 142 that includes a first coupling portion 144 and a second coupling portion 146. The mounting bar 102B may be operably coupled with the first coupling portion 144 via the fastening elements 148, 150. Optionally, the mounting bar 102B may be operably coupled with the first coupling portion 144 of the clamping device 142 via an alternative arrangement, via one or more additional or alternative fastening elements, via an alternative coupling system, or the like.

The second coupling portion 146 of the clamping device 142 may include an opening or passage 152 that may receive a portion of a frame structure 154 of an aircraft system. In one example, a size and/or shape of the opening of the passage 152 may be adjusted such as to allow for the clamping device 142 to support the frame structure 154 that includes or is devoid insulation, as opposed to the clamping device 142 penetrating through a portion of insulation of the frame structure 154 (not shown). In one or more examples, the fastener system 140 may eliminate the need for secondary mounting brackets on the frame structure 154 (not shown), thereby reducing installation time of the conduit system 100 within the aircraft, weight, reduced part count, etc. In one or more examples, the frame structure 154, including an insulation material of the frame structure (not shown) may extend through the passage 152 without the clamping device 142 penetrating through a portion of the insulation may control an amount and/or level of moisture that may be able to pass through the frame structure 154, thereby controlling an amount or level of moisture that may be allowed to pass through into an interior passenger cabin of the aircraft.

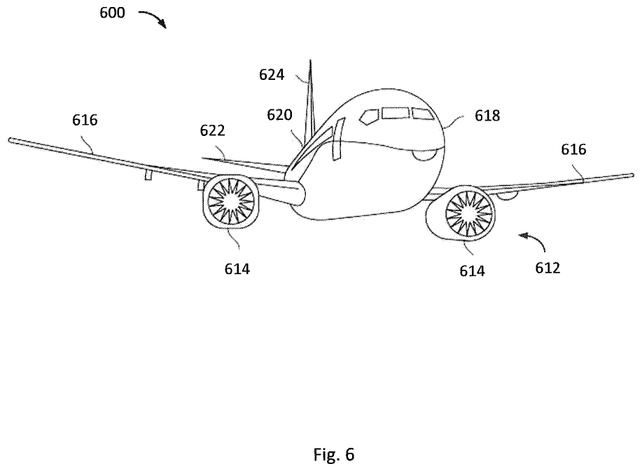

FIG. 6 illustrates a perspective view of an aircraft 600, according to an example of the present disclosure. The aircraft 600 includes a propulsion system 612 that may include two turbofan engines 614, for example. Optionally, the propulsion system 612 may include more engines 614 than shown. The engines 614 are carried by wings 616 of the aircraft 600. In other examples, the engines 614 may be carried by a fuselage 618 and/or an empennage 620. The empennage 620 may also support horizontal stabilizers 622 and a vertical stabilizer 624.

In one or more examples, the conduit system 100 may be disposed within the fuselage 618 of the aircraft 600. As one example, the conduits 104 may be positioned, arranged, shaped, and/or sized to hold wire bundles that may extend along a portion of a length of the fuselage 618 at a location within the fuselage 618. As another example, one or more of the conduits 104 may be positioned, arranged, shaped, and/or sized to hold and/or direct a fluid (e.g., a gas, liquid, gas-liquid mixture, or the like) in one or more directions.

In one example, the conduit system 100 may be installed within the aircraft 600 below a floor of an interior cabin of the aircraft, proximate to floor beams or another surface of the aircraft, or the like. The mounting bars 102 and the conduits 104 may be positioned to maintain a position of wire bundles or other objects disposed within the conduits at a location proximate a surface of the aircraft 600. Optionally, the conduit system 100 may be used within another vehicle (e.g., automobiles, buses, locomotives, train cars, watercraft, spacecraft, etc.), may be used within a stationary structure (e.g., a building, a warehouse, a residence, etc.), or the like.

In one or more examples, the frame structure 154 may have an alternative shape, size, arrangement, or the like, may include an insulating layer or insulating cap element, or the like, extending around a portion of an outer surface of the frame structure 154, or the like. For example, the cross-sectional view shown in FIG. 5 illustrates one example of a fastener system 140 that may be used to couple the mounting bar 102B (and the conduit system) with a portion of the frame structure 154. The passage 152 of the clamping device 142 may be shaped and/or sized to accommodate the frame structure 154 having the alternative shape, size, arrangement, including an insulation layer or insulating cap element, etc.

In one or more examples, any number of fastener systems 140, clamping devices 142, fastening elements 148, 150, or the like, may be used to couple the mounting bar 102B with the frame structure 154 of the aircraft system, may be used to couple the mounting bars 102A, 102C (shown in FIG. 1) to another portion of the frame structure of the aircraft system, or the like. Optionally, one or more fastener systems of the mounting bar 102B having an alternative arrangement, alternative fastening elements, or the like, of another fastener system (not shown) that may be used to couple another portion of the mounting bar 102B with another portion of an aircraft system.

In one or more examples, the mounting bar 102B may include one or more passages 134 that may be used to couple the mounting bar 102B with the frame structure 154. Optionally, one or more of the mounting bars 102A-C (shown in FIG. 1) may include one or more passages for coupling the mounting bars with a portion of a frame structure. In one or more examples, one of the mounting bars may be coupled with a portion of a frame structure via an alternative fastener system, an alternative fastening arrangement, or the like. For example, a fastener system of a first mounting bar 102A may be the same as, similar to, or different than a fastener system of a second mounting bar 102B.

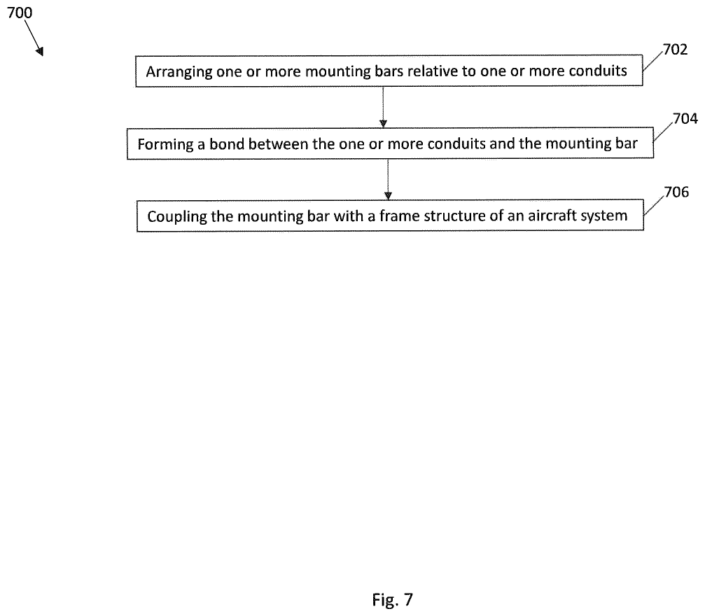

FIG. 7 illustrates a flow chart 700 of one example of a method, according to an example of the present disclosure. At 702, one or more mounting bars may be arranged relative to one or more conduits. At 704, the one or more conduits may be operably coupled with the mounting bars. As one example, the outer surfaces of the conduits may be operably coupled with mating features of mating surfaces of the mounting bars. The conduits and the mounting bars may be operably coupled via a thermal bond, an adhesive bond, a mechanical connection, or the like. At 706, one or more of the mounting bars may be operably coupled with a portion of a frame structure, such as a frame structure of an interior portion of an aircraft system.

As described herein, examples of the present disclosure provide conduit systems and methods for forming conduit systems and installing conduit systems within a structure, such as an aircraft system, a building, or the like. The conduits systems may include mounting bars having one or more mating features. As one example, the mating features may be concave pockets or cutouts that extend into a body of the mounting bars. The concave features may be shaped and sized based at least in part on a conduit to which the mounting bar will be coupled. For example, a curvature or diameter of the conduit may be substantially the same as a curvature or diameter of the concave feature of the mounting bar. The mounting bars and the conduits may both be manufactured of a thermoplastic fluoropolymer such that the mounting bars may be thermally bonded to the conduits. Optionally, the mounting bars and/or the conduits may be manufactured of an alternative material and the mounting bars may be adhesively coupled to the conduits, such as by an adhesive material disposed between an outer surface of the conduit and a mating surface of the mounting bar. The conduit system may be installed within a structure, such as an aircraft or building, via one or more fastener systems. The fastener systems may include one or more clamping devices, fastening elements (e.g., spacers, screws, bolts, rivets, hooks, pins, or the like), or the like, that may be used to mechanically couple the mounting bars with the structure.

Examples of the present disclosure provide mounting and/or installation structures that may have a reduced weight, reduced number of components, or the like, relative to conduit systems that are not thermally bonded and/or adhesively bonded together. Additionally, the present disclosure provides conduit systems and mounting structures that are manufactured of a flexible material that is allowed to flex, move, stretch, or the like, such as during assembly and/or installation. The flexible material may allow for tolerances between two or more mating elements to be opened, widened, or the like. The conduit system having a reduced weight, reduced number of parts or components, improved mating tolerances, or the like, may improve an assembly process and/or an installation process of the conduit systems within an aircraft system relative to conduit systems manufactured of metallic alloys.

Further, the disclosure comprises examples according to the following clauses:
Clause 1: a conduit system, comprising:
   a mounting bar extending between a first end and a second end, the mounting bar including a mating surface that extends between the first end and the second end, the mating surface including one or more mating features; and
   one or more conduits each comprising an outer surface configured to be operably coupled with at least one of the one or more mating features of the mounting bar,
   wherein the one or more conduits are configured to be operably coupled with the mating surface of the mounting bar via one of a thermal bond or an adhesive bond.
Clause 2: the conduit system of clause 1, wherein the mounting bar and the one or more conduits are configured to be manufactured of a flexible material.
Clause 3: the conduit system of clauses 1 or 2, wherein the mounting bar is configured to be manufactured of a first material that has one or more first characteristics, and the one or more conduits are configured to be manufactured of a second material that has one or more second characteristics, wherein at least one of the first characteristics is the same as at least one of the second characteristics.
Clause 4: the conduit system of any of clauses 1-3, wherein the mounting bar and the one or more conduits are configured to be manufactured of a thermoplastic fluoropolymer.
Clause 5: the conduit system of any of clauses 1-4, wherein the one or more mating features of the mounting bar are configured to have one or more of a shape or a size that corresponds to one or more of a shape or a size of at least one of the one or more conduits.
Clause 6: the conduit system of any of clauses 1-5, wherein the mounting bar is configured to maintain a position of the one or more conduits.
Clause 7: the conduit system of any of clauses 1-6, wherein the conduit system includes a first conduit and a second conduit, wherein the mounting bar is configured to maintain a position of the first conduit relative to a position of the second conduit.
Clause 8: the conduit system of any of clauses 1-7, wherein the mounting bar and the one or more conduits are configured to be disposed within an interior portion of an aircraft system.
Clause 9: the conduit system of any of clauses 1-8, the mounting bar further comprising one or more passages configured to receive one or more fastening elements, wherein the mounting bar is configured to be operably coupled with a portion of a frame structure of an aircraft system via the one or more fastening elements.
Clause 10: the conduit system of any of clauses 1-9, further comprising a fastener system comprising one or more clamping devices and one or more fastening elements, wherein the mounting bar includes one or more passages configured to receive the one or more fastening elements.
Clause 11: the conduit system of clause 10, wherein each of the one or more clamping devices include a first coupling portion and a second coupling portion, wherein the first coupling portion is configured to be operably coupled with the mounting bar via the one or more fastening elements and the second coupling portion is configured to be operably coupled with a frame structure of an aircraft system.
Clause 12: a conduit system, comprising
   one or more conduits, each of the one or more conduits extending a length in a first direction, each of the one or more conduits including an outer surface; and
   plural mounting bars, each of the mounting bars disposed at different locations along the length of the one or more conduits, each of the mounting bars comprising a mating surface that includes one or more mating features,
   wherein the one or more conduits are configured to be operably coupled with at least one of the mating features of each of the mounting bars via one of a thermal bond or an adhesive bond.
Clause 13: the conduit system of clause 12, wherein the mounting bars extend in a second direction between first ends and second ends of the mounting bars, wherein the second direction is substantially perpendicular to the first direction.
Clause 14: the conduit system of clauses 12 or 13, wherein the mounting bars and the one or more conduits are configured to be manufactured of a flexible material.
Clause 15: the conduit system of any of clauses 12-14, wherein the mounting bars and the one or more conduits are configured to be manufactured of a thermoplastic fluoropolymer.
Clause 16: the conduit system of any of clauses 12-15, wherein one or more characteristics of the mating features of a first mounting bar of the plural mounting bars are the same as one or more characteristics of the mating features of a second mounting bar of the plural mounting bars.
Clause 17: the conduit system of clause 16, wherein the one or more characteristics include one or more of shape, size, or relative position along the mating surface of the first and second mounting bars between a first end and a second end of the first and second mounting bars.
Clause 18: the conduit system of any of clauses 12-17, wherein the mounting bars and the one or more conduits are configured to be disposed within an interior portion of an aircraft system.
Clause 19: the conduit system of any of clauses 12-18, wherein one or more of the mounting bars further comprises one or more passages configured to receive one or more fastening elements, wherein the one or more mounting bars are configured to be operably coupled with a portion of a frame structure of an aircraft system via the one or more fastening elements.
Clause 20: a method, comprising:
   forming a thermal bond between a mating feature of a mounting bar with one or more outer surfaces of one or more conduits, the mating feature disposed along a mating surface of the mounting bar, the mounting bar extending between a first end and a second end in a first direction, the one or more conduits extending in a second direction that is different than the first direction, wherein the mounting bar and the one or more conduits are configured to be manufactured of a thermoplastic fluoropolymer.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A conduit system, comprising:
a mounting bar extending between a first end and a second end, the mounting bar including a mating surface that extends between the first end and the second end, the mating surface including one or more mating features; and
one or more conduits each comprising an outer surface configured to be operably coupled with at least one of the one or more mating features of the mounting bar,
wherein the one or more conduits are configured to be operably coupled with the mating surface of the mounting bar via one of a thermal bond or an adhesive bond.

2. The conduit system of claim 1, wherein the mounting bar and the one or more conduits are configured to be manufactured of a flexible material.

3. The conduit system of claim 1, wherein the mounting bar is configured to be manufactured of a first material that has one or more first characteristics, and the one or more conduits are configured to be manufactured of a second material that has one or more second characteristics, wherein at least one of the first characteristics is the same as at least one of the second characteristics.

4. The conduit system of claim 1, wherein the mounting bar and the one or more conduits are configured to be manufactured of a thermoplastic fluoropolymer.

5. The conduit system of claim 1, wherein the one or more mating features of the mounting bar are configured to have one or more of a shape or a size that corresponds to one or more of a shape or a size of at least one of the one or more conduits.

6. The conduit system of claim 1, wherein the mounting bar is configured to maintain a position of the one or more conduits.

7. The conduit system of claim 1, wherein the conduit system includes a first conduit and a second conduit, wherein the mounting bar is configured to maintain a position of the first conduit relative to a position of the second conduit.

8. The conduit system of claim 1, wherein the mounting bar and the one or more conduits are configured to be disposed within an interior portion of an aircraft system.

9. The conduit system of claim 1, the mounting bar further comprising one or more passages configured to receive one or more fastening elements, wherein the mounting bar is configured to be operably coupled with a portion of a frame structure of an aircraft system via the one or more fastening elements.

10. The conduit system of claim 1, further comprising a fastener system comprising one or more clamping devices and one or more fastening elements, wherein the mounting bar includes one or more passages configured to receive the one or more fastening elements.

11. The conduit system of claim 10, wherein each of the one or more clamping devices include a first coupling portion and a second coupling portion, wherein the first coupling portion is configured to be operably coupled with the mounting bar via the one or more fastening elements and the second coupling portion is configured to be operably coupled with a frame structure of an aircraft system.

12. A conduit system, comprising
one or more conduits, each of the one or more conduits extending a length in a first direction, each of the one or more conduits including an outer surface; and
plural mounting bars, each of the mounting bars disposed at a different location along the length of the one or more conduits, each of the mounting bars comprising a mating surface that includes one or more mating features,
wherein the one or more conduits are configured to be operably coupled with at least one of the mating features of each of the mounting bars via one of a thermal bond or an adhesive bond.

13. The conduit system of claim 12, wherein the mounting bars extend in a second direction between first ends and second ends of the mounting bars, wherein the second direction is substantially perpendicular to the first direction.

14. The conduit system of claim 12, wherein the mounting bars and the one or more conduits are configured to be manufactured of a flexible material.

15. The conduit system of claim 12, wherein the mounting bars and the one or more conduits are configured to be manufactured of a thermoplastic fluoropolymer.

16. The conduit system of claim 12, wherein one or more characteristics of the mating features of a first mounting bar of the plural mounting bars are the same as one or more characteristics of the mating features of a second mounting bar of the plural mounting bars.

17. The conduit system of claim 16, wherein the one or more characteristics include one or more of shape, size, or relative position along the mating surface of the first and second mounting bars between a first end and a second end of the first and second mounting bars.

18. The conduit system of claim 12, wherein the mounting bars and the one or more conduits are configured to be disposed within an interior portion of an aircraft system.

19. The conduit system of claim 12, wherein one or more of the mounting bars further comprises one or more passages configured to receive one or more fastening elements, wherein the one or more mounting bars are configured to be operably coupled with a portion of a frame structure of an aircraft system via the one or more fastening elements.

20. A method, comprising:
forming a thermal bond between a mating feature of a mounting bar with one or more outer surfaces of one or more conduits, the mating feature disposed along a mating surface of the mounting bar, the mounting bar extending between a first end and a second end in a first direction, the one or more conduits extending in a second direction that is different than the first direction, wherein the mounting bar and the one or more conduits are configured to be manufactured of a thermoplastic fluoropolymer.
